(19) United States
(12) Patent Application Publication
(10) Pub. No.: US 2009/0251622 A1
(43) Pub. Date: Oct. 8, 2009

(54) Electronic Device

(75) Inventors: Setsu Mitsuhashi, Tokyo (JP); Hirotake Nozaki, Port Washington, NY (US); Nobuhiro Fujinawa, Yokohama-shi (JP); Akira Ohmura, Tokyo (JP)

Correspondence Address: OLIFF & BERRIDGE, PLC, P.O. BOX 320850, ALEXANDRIA, VA, 22320-4850, US

(73) Assignee: NIKON CORPORATION, Tokyo (JP)

(21) Appl. No.: 12/083,017

(22) PCT Filed: Oct. 2, 2006
(86) PCT No.: PCT/JP2006/319687

§ 371 Date: Jun. 5, 2008

(30) Foreign Application Priority Data
Oct. 7, 2005 (JP) 2005-294845

(51) Int. Cl. H04N 3/26

(52) U.S. Cl. 348/745; 348/E03.048

(57) ABSTRACT

An electronic device includes: a first image reproduction unit that reproduces an image; a second image reproduction unit that reproduces an image at a resolution different from that of the first image reproduction unit; a reproduction data generation unit that generates reproduction data at a resolution according to an image reproduction unit by using image data; and a control unit that instructs one of the first image reproduction unit and the second image reproduction unit alternatively image reproduction in response to a switching instruction, and that controls the reproduction data generation unit to generate reproduction data according to a resolution of an image reproduction unit that is instructed.

### TECHNICAL FIELD

A present invention relates to an electronic device which includes a plurality of image reproduction means.

### BACKGROUND ART

A display device which can reproduce a reproduction image using a plurality of image reproduction means is known (Refer to Patent Document 1)—According to Patent Document 1, a mode for reproduction of the same image using a plurality of image reproduction means and a mode for reproduction of different images using a plurality of image reproduction means are equipped.

Patent Document 1: Japanese Laid Open Patent Publication No. 2002-341438

### DISCLOSURE OF THE INVENTION

### Problems to be Solved by the Invention

There is a demand for image reproduction using either of a plurality of image reproduction means.

### Means for Solving the Problems

According to a first aspect of the present invention, an electronic device includes: a first image reproduction unit that reproduces an image; a second image reproduction unit that reproduces an image at a resolution different from that of the first image reproduction unit; a reproduction data generation unit that generates reproduction data at a resolution according to an image reproduction unit by using image data; and a control unit that instructs one of the first image reproduction unit and the second image reproduction unit alternatively image reproduction in response to a switching instruction, and that controls the reproduction data generation unit to generate reproduction data according to a resolution of an image reproduction unit that is instructed.

According to a second aspect of the present invention, in the electronic device according to the first aspect, it is also possible that the control unit instructs the image reproduction, and controls the reproduction data generation unit, in response to one of an operation signal from an operation member, a cable connection detection signal, and an instruction through an operation menu.

According to a third aspect of the present invention, in the electronic device according to the first aspect, the control unit can instruct the image reproduction and control the reproduction data generation unit, with respect to an image reproduction unit indicated by management information of reproduction data.

According to a fourth aspect of the present invention, in the electronic device according to the third aspect, it is preferable that the management information of the reproduction data is stored in a file other than a file in which image data is stored, and an image reproduction unit that reproduces an image is indicated for each file in which image data is stored.

According to a fifth aspect of the present invention, in the electronic device according to the third aspect, it is preferable that the management information of the reproduction data is stored in a file other than a file in which image data is stored, and an image reproduction unit that reproduces an image is indicated for each folder for storing a file in which image data is stored.

According to a sixth aspect of the present invention, in the electronic device according to the third aspect, it is preferable that the management information of the reproduction data is stored in a file other than a file in which image data is stored, and an image reproduction unit that reproduces an image is indicated for each recording media for storing a file in which image data is stored.

According to a seventh aspect of the present invention, in the electronic device according to any one of the first to sixth aspects, the first image reproduction unit may be a projection device.

According to a eighth aspect of the present invention, an electronic device includes: a first image reproduction unit that reproduces an image; a second image reproduction unit that reproduces an image differently from the first image reproduction unit; and a reproduction control unit that independently controls reproduction and non-reproduction of an image by means of the first image reproduction unit and the second image reproduction unit, in response to a first instruction which indicates whether or not to instruct the first image reproduction unit to reproduce an image, and a second instruction which indicates whether or not to instruct the second image reproduction unit to reproduce an image.

According to a ninth aspect of the present invention, in the electronic device according to the eighth aspect, it is preferable that the first instruction and the second instruction are given to each file where data of an image to be reproduced is stored.

According to a tenth aspect of the present invention, in the electronic device according to the ninth aspect, it is preferable that when instructing each of the first image reproduction unit and the second image reproduction unit to reproduce an image, the reproduction control unit (1) instructs the first image reproduction unit to reproduce and display, among images that are instructed to be reproduced by the second instruction, an image that is instructed to be reproduced by the first instruction; (2) instructs the first image reproduction unit to display information that shows non-reproduction related to, among images that are instructed to be reproduced by the second instruction, an image that is not instructed to be reproduced by the first instruction; and (3) instructs the second image reproduction unit to reproduce and display an image that is instructed to be reproduced by the second instruction.

According to a eleventh aspect of the present invention, in the electronic device according to the ninth aspect, it is preferable that when instructing only the first image reproduction unit to reproduce an image, the reproduction control unit (1) instructs the first image reproduction unit to reproduce and display, among images that are stored in all files, an image that is instructed to be reproduced by the first instruction; and (2) instructs the first image reproduction unit to display information which shows non-reproduction related to, among the images that are stored in all the files, an image that is not instructed to be reproduced by the first instruction.

According to a twelfth aspect of the present invention, in the electronic device according to the ninth aspect, it is preferable that when instructing only the second image reproduction unit to reproduce an image, the reproduction control unit instructs the second image reproduction unit to reproduce and display an image that is instructed to be reproduced by the second instruction.

According to a thirteenth aspect of the present invention, in the electronic device according to any one of the eighth to twelfth aspects, the first image reproduction unit may be a liquid crystal display device, and the second image reproduction unit may be a projection device.

The above first image reproduction unit may be replaced by a first image reproduction means.

The above second image reproduction unit may be replaced by a second image reproduction means.

The above reproduction data generation unit may be replaced by a reproduction data generation means.

The above control unit may be replaced by a control means.

The above reproduction control unit may be replaced by a reproduction control means.

### ADVANTAGEOUS EFFECT OF THE INVENTION

With the present invention, an electronic device for image reproduction using any of a plurality of image reproduction means can be provided at low cost.

With an other invention, an electronic device for image reproduction using any of a plurality of image reproduction means can be provided.

### BRIEF DESCRIPTION OF THE DRAWINGS

FIG. 1 is an oblique perspective figure of a projector in a first embodiment of the present invention.

FIG. 2 is a block diagram illustrating a configuration of the projector.

FIG. 3 is a drawing illustrating an example of “Setting Menu of Display Device” screen.

FIG. 4 is a drawing illustrating a management file in which management information of reproduction data is recorded.

FIG. 5 is a drawing illustrating a management file in which management information of reproduction data is recorded.

FIG. 6 is a drawing illustrating an example of a menu screen in a fifth embodiment.

FIG. 7 is a flowchart illustrating a flow of reproduction processing.

FIG. 8 is a drawing illustrating an example of a list display screen that is displayed on a liquid crystal display unit.

FIG. 9 is a drawing illustrating an example of a list display screen that is projected from a projector unit.

FIG. 10 is a drawing illustrating an example of a list display screen that is displayed on a liquid crystal display unit.

FIG. 11 is a drawing illustrating an example of a list display screen that is displayed on a liquid crystal display unit.

### BEST MODE FOR CARRYING OUT THE INVENTION

Hereinafter, descriptions for a best mode for carrying out the invention are given with reference to the drawings.

### FIRST EMBODIMENT

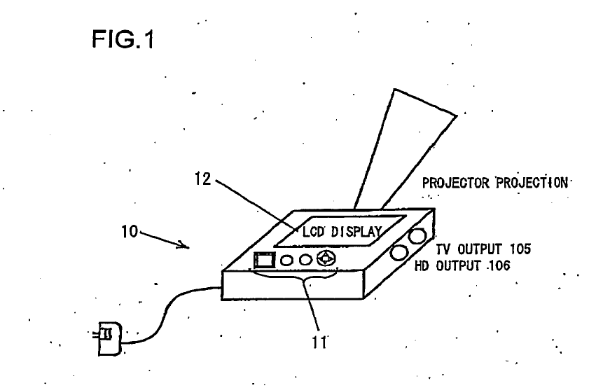

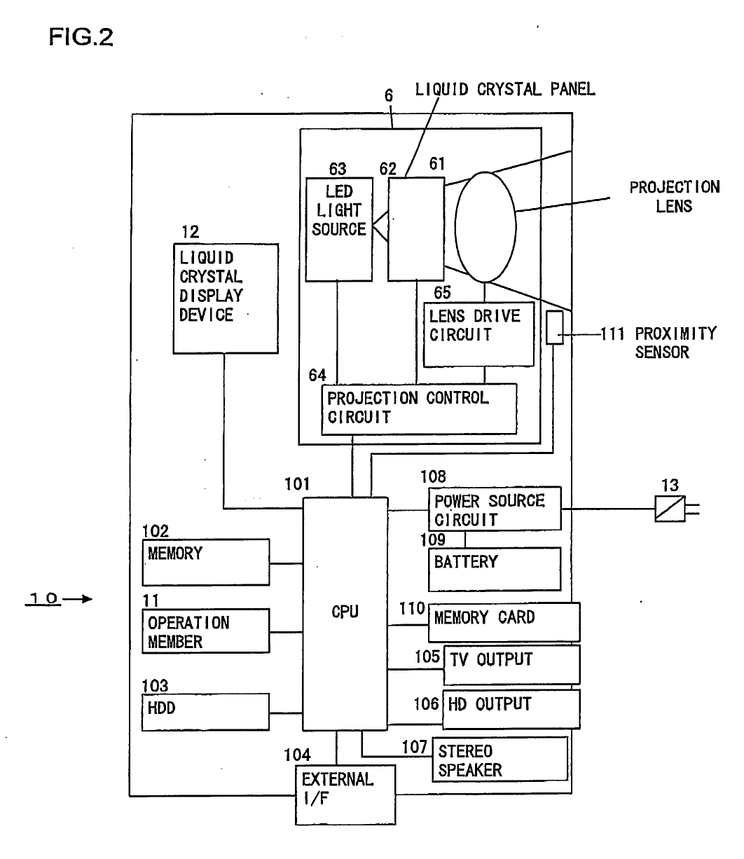

FIG. 1 is an oblique perspective figure of a projector in a first embodiment of the present invention. In FIG. 1, a projector 10 includes an operation member 11, a liquid crystal display device 12, a TV output terminal 105, a HD output terminal 106, and a projector unit 6 (FIG. 2) described hereinafter, and is powered through a AC/DC adapter 13.

The projector 10 is to be placed on a desktop, etc., and projects information such as an image on a screen or a wall. The projector 10 is configured to be able to, as substitute for projecting information, display information on the liquid crystal display device 12, or to display information on an external TV monitor (not figured herein) or an external HD monitor (not figured herein). An HD monitor is a high-definition TV monitor with larger number of scanning lines than that of a normal TV monitor. The projector 10 outputs a picture signal to be displayed on the TV monitor from the TV output terminal 105, and outputs a picture signal to be displayed on the HD monitor from the HD output terminal 106.

FIG. 2 is a block diagram illustrating the configuration of Projector 10 which is described above. In FIG. 2, The projector 10 includes a projector unit 6, a CPU 101, a memory 102, the operation member 11, the liquid crystal display device 12, a hard disk drive device (HDD) 103, an external interface (I/F) 104, the TV output terminal 105, the HD output terminal 106, a stereo speaker 107, a power source circuit 108, and a proximity sensor 111. A card slot which is not figured herein is mounted with a detachable memory card 110. A battery folder which is not figured herein is loaded with a battery 109.

The projector 10 reads out image data (image file) photographed using an electronic camera from the memory card 110 or the hard disk drive device (HDD) 103, etc., to project a reproduction image by the image data using the projector unit 6 and to display the image on the liquid crystal display device 12. The projector 10 is also possible to project (or display) a reproduction image by image data supplied from an external device through the external interface (I/F) 104, other than image data saved in the projector 10. The projector 10, furthermore, copies reproduction data and saves the data on the hard disk drive device (HDD) 103, and creates and saves management information of the reproduction data.

Based on a control program, the CPU 101, by means of carrying out a predetermined operation using signals that are input from each unit that makes up the projector 10, etc., sends out control signals to each unit of the projector 10, to carry out control of information reproduction operation by the projector 10. And, the control program is stored in a nonvolatile memory which is not figured herein in the CPU 101.

The memory 102 is used as a working memory of the CPU 101. The operation member 11 includes a plurality of operation components including a main switch, a display device selector switch, a source selector switch, an arrow key, and so on. The operation member 11 sends out an operation signal to the CPU 101 according to operation contents.

The memory card 110 includes a nonvolatile memory such as a flash memory and so on. In response to instructions from the CPU 101, image data and sound data can be written in, saved in and read out from the memory card 110. The hard disk drive device (HDD) 103 is a recording device whose capacity is larger than that of the memory card 110. In response to instructions from CPU 101, the hard disk drive device (HDD) 103 enables to write, save and read out data, such as image data and sound data.

The external interface (I/F) 104 converts video signals sent from an external device such as a video camera, into image data, and sends out the converted image data to the CPU 101. And, the external interface (I/F) 104 converts signals sent from an external device into sound data for reproducing with the speaker 107, and sends out the converted sound data to the CPU 101.

In response to instructions from the CPU 101, the liquid crystal display device 12 reproduces and displays information of image and text. Text information includes an operating state of the projector 10, an operation menu, and so on. When the CPU 101 instructs the liquid crystal display device 12 to reproduce and display, reproduction data is generated according to a display resolution of the liquid crystal display device 12 (for example, 320 pixels wide×200 pixels long) using the image data, and the generated data is sent to the liquid crystal display device 12. The stereo speaker 107 reproduces a sound by sound data that is output from the CPU 101.

The battery 109 includes a chargeable secondary battery and supplies power to each unit of the projector 10. The power source circuit 108 includes a charge circuit and a voltage detecting circuit, converts voltage of the battery 109 into a voltage that is necessary for each unit of the projector 10, as well as, in case a voltage of the battery 109 is low and a remaining battery has been decreased, charges the battery 109 with a charging current that is supplied through the AC/DC Adapter 13.

On a chassis of the projector 10, the proximity sensor 111 is mounted on a side that has an opening of the projector unit 6, being juxtaposed to the opening. The proximity sensor 111 includes a LED that emits an infrared light and a photodiode that receives the infrared light, and sends a detection signal to CPU 101 when the received infrared light is beyond a predetermined level.

When the chassis of the projector 10 is placed the opening side of the projector unit 6 down, or when the opening side is too close to an other object such as a screen, the infrared light that LED emits is reflected on the placed surface or the object and is received in the photodiode.

### (Projector Unit)

In response to instructions from the CPU 101, the projector Unit 6 reproduces and projects information such as image, text, and so on. The projector unit 6 includes a projection lens 61, a liquid crystal panel 62, a LED light source 63, a projection control circuit 64, and a lens drive circuit 65. The projection control circuit 64 supplies a drive current to the LED light source 63 in response to an projection instruction that is output from the CPU 101. The LED light source 63 illuminates the liquid crystal panel 62 at a brightness according to a supplied current.

When the CPU 101 instructs the projector unit 6 to reproduce and project, reproduction data is generated according to a display resolution of the liquid crystal panel 62 (corresponds to a projection resolution of the projector unit 6; for example, 640 pixels wide×400 pixels long) using the image data, the generated data is sent to the projector unit 6. The projection control circuit 64 generates a liquid crystal panel drive signal according to the reproduction data sent out from the CPU 101, and drives the liquid crystal panel 62 with the generated drive signal. Concretely speaking, a voltage which is corresponding to reproduction data is applied to a liquid crystal layer for each pixel. A liquid crystal molecular orientation of the liquid crystal layer to which the voltage is applied changes, and a light transmission rate of the liquid crystal layer changes. Thus, modulating a light from the LED sight source 63 according to the reproduction data leads the liquid crystal panel 62 to generate a light image.

The projection lens 61 projects an optical image projected from the liquid crystal panel 62 to a screen and so on. The lens drive circuit 65 drives the projection lens 61 back and forth in a direction perpendicular to an optical axis, based on an offset adjustment signal which is output from the projection control circuit 64. And, the lens drive circuit 65 drives a focus lens (not figured herein) that makes up the projection lens 61 back and forth in a direction of the optical axis, based on a focus adjustment signal that is output from the projection control circuit 64. The lens drive circuit 65 furthermore drives a zoom lens (not figured herein) that makes up the projection lens 61 back and forth in a direction of the optical axis, based on a zoom adjustment signal that is output from the projection control circuit 64. An amount of the offset adjustment, an amount of the focus adjustment, and an amount of the zoom adjustment are instructed from the CPU 101 to the projection control circuit 64.

### (Offset of a Projection Image)

The projection lens 61 being shifted in the direction perpendicular to the optical axis changes a projection direction of a light flux that is projected from the projector unit 6, and a projection image is offset. The offset of a projection image may as well be achieved by shifting the liquid crystal panel 62, the LED light source 63 in the direction perpendicular to the optical axis, other than by shifting the projection lens 61. That is to say, changing a relative position between Projection Lens 61 and Liquid Crystal Panel 62 in the direction perpendicular to the optical axis enables the offset of a projection image.

### (Keystone Correction of a Projection Image)

When shifting any of the projection lens 61, the liquid crystal panel 62, and the LED light source 63 in the direction perpendicular to the optical axis, a keystone correction is made to data for projecting according to an amount of the shifting. Since simply giving the offset to a projection image ends up trapezoidally distorting the projection image, the CPU 101 makes an electric keystone correction by means of image processing in order to correct the projection image from the trapezoidal shape into a rectangle shape. In a memory of the CPU 101, an initial correction value for correcting a projection image into a rectangle shape is stored in advance. The CPU 101 reads out an initial correction value that corresponds to the offset adjustment amount, performs a keystone correction processing to data of a projection image in the memory 102 based on the initial correction value which is read out, and sends out image data to which the keystone correction processing is performed to the projection control circuit 64.

### (Focus Adjustment of a Projection Image)

The projector unit 6 performs a focus adjustment of a projection image by shifting a focus lens that makes up the projection lens 61 in the direction of the optical axis. When performing the focus adjustment, the CPU 101 sends a focus adjustment signal to the projection control circuit 64 in response to an operation signal from the operation member 11.

### (Zoom Adjustment of a Projection Image)

The projector unit 6 performs a zoom adjustment of a projection image by shifting a zoom lens that makes up the projection lens 61 in the direction of the optical axis. The CPU 101 sends a zoom adjustment signal to the projection control circuit 64 in response to the operation signal from the operation member 11.

### (Safety Device)

When a detection signal from the proximity sensor 111 is input, the CPU 101 prohibits projection from the projector unit 6. At the time of the projection prohibition, at least illumination with the LED light source 63 is powered off.

### (Display Device Switching)

It is set using a display device selector switch whether the CPU 101 instructs the projector unit 6 to reproduce an image, instructs the liquid crystal display device 12 to reproduce an image, instructs an external TV monitor to display, or instructs an external HD monitor to display. Every time a display device switching operation signal is input from the display device selector switch that makes up the operation member 11, the CPU 101 switches cyclically display devices for the image reproduction in order of “Projector Unit 6”, “Liquid Crystal Display Device 12”, “TV Monitor”, “HD Monitor”, “Projector Unit 6”, and so on.

When projecting from the projector unit 6, the CPU 101 sends a projection instruction to the projector unit 6. When displaying with the liquid crystal display device 12, the CPU 101 sends a display instruction to the liquid crystal display device 12. When displaying on a TV monitor, the CPU 101, for example, generates a picture signal that corresponds to the number of scanning lines of 525, and outputs the generated signal from the TV output terminal 105. When displaying on a HD monitor, the CPU 101, for example, generates a picture signal that corresponds to the number of scanning lines of 1125, and outputs the generated signal from the HD output terminal 106.

### (Source Switching)

It is set using a source selector switch which content image for the CPU 101 to instruct to reproduce. Every time a source switching operation signal is input from the source selector switch that makes up the operation member 11, the CPU 101 switches cyclically contents for the image reproduction in order of Source 1, Source 2, Source 3, Source 1, and so on, and changes a source of image data. However, Source 1 is skipped when the memory card 110 is not mounted on the projector 10. And, Source 3 is skipped when any external device is not connected to the external interface (I/F) 104.

Source 1. A reproduction image by data read out from the memory Card 110
Source 2. A reproduction image by data read out from the hard disk drive device (HDD) 103
Source 3. A reproduction image by data input from the external interface (I/F) 104

When reproducing an image that corresponds to the source 1. or the source 2., the CPU 101 reads out image data with a record of a latest date and hour (one that was photographed last among recorded image data) in order from the memory card 110 (or, Hard Disk Drive Device 103). Data that is read out is used for generating reproduction data to be sent out to the projector unit 6 or the liquid crystal display device 12 and also is used for generating a picture signal that is output to an external TV monitor (or an HD monitor).

According to the first embodiment that is described above, the following operations and advantageous effects can be achieved.

(1) Depending on a display device which is set, any one of display data, projection data, and picture signals with different resolution is alternatively generated; the CPU 101 can be shared as a reproduction data generation means among the projector unit 6, the liquid crystal display device 12, an external TV monitor, and an external HD monitor, and cost reduction can be made. And, since sets of data (picture signals) with a plurality of resolutions are not necessary to be generated simultaneously, a burden on the CPU 101 is reduced and reproduction images can be displayed (projected) at a pleasant speed even without a CPU for high-speed processing.
(2) Since generating reproduction data (or picture signals) at a resolution according to the display device is performed in real time at the time of image reproducing, it is not necessary for display data, projection data, or picture signals with a different resolution to be generated in advance and to be stored in a memory device such as the hard disk drive device (HDD) 103. This enables to save an open storage space of the memory device.
(3) Since the projection by the projector unit 6 is prohibited in case of a detection signal being input from the proximity sensor 111, an unnecessary projection operation is prevented, at the same time, power consumption and heat generation can also be reduced.

### (Example of Variation 1)

As substitute for the proximity sensor 111, a configuration with which a mechanical switch is equipped may as well be taken. In this case, on the chassis of the projector 10, a micro switch is put on the side that has the opening of the projector unit 6. The micro switch outputs a detection signal to the CPU 101, in case the chassis of the projector 10 is placed the aperture side of the projector unit 6 down, or in case the opening side is in contact with an other object.

### SECOND EMBODIMENT

As substitute for an operation signal from the display device selector switch, a configuration that a display device switching can be set on “Menu Screen” may as well be taken. A description of menu settings made to the projector 10 in this case follows.

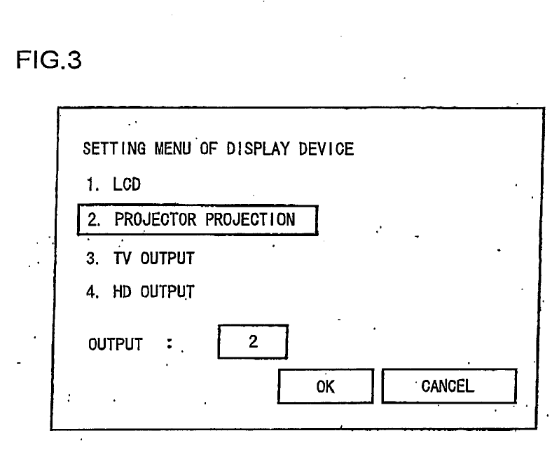

When a push down operation is made to a menu key that makes up the operation member 11, the projector 10 causes the liquid crystal display device 12 to display “Setting Menu of Display Device” screen. FIG. 3 is a drawing that illustrates an example of “Setting Menu of Display Device” screen. In FIG. 3, four items, “1. LCD”, “2. Projector Projection”, “3. TV Output”, and “4. HD Output”, are being displayed.

In this state, if a cursor key (an arrow key) for screen operations that makes up the operation member 11 is operated downwards, Projector 10 moves the cursor position downwards, when the arrow key is operated upwards, the projector 10 moves the cursor position upwards. An upward and downward operation signal by the arrow key in the menu screen display corresponds to an item selection instruction. In the example of FIG. 3, the cursor is positioned on an item of “2.Projector Projection”. And, an item on which the cursor is positioned in “Setting Menu of Display Device” screen, when the screen is started up first in response to the push down operation of the menu key, represents a display device having been set at the time.

In conjunction with the item selection instruction, the projector 10 causes “Output” box that represents a display device to display an item number (that is “2” in the example of FIG. 3) on which the cursor is positioned. When the arrow key 11 that makes up the operation member 11 is operated leftwards, the projector 10 causes displaying a check box “OK” and moreover, when a push down operation is made to the menu key, quits displaying “Setting Menu of Display Device” screen and determines a display device that corresponds to the number displayed in “Output” box. That is to say, a setting of a display device is changed into the projector unit 6.

When the arrow key 11 that makes up the operation member 11 is operated rightwards, the projector 10 causes displaying a check box “Cancel” and moreover, when a push down operation is made to the menu key, regardlessly of a number displayed in “Output” box, returns to setting contents before the menu screen display, and quits displaying “Setting Menu of Display Device” screen. In this case, a setting of a display device is not changed.

According to the second embodiment that is described above, since display device switching is configured to be settable in “Menu Screen”, a display device switching state can be informed to a user. That is to say, the user can confirm the setting state of display devices from the menu screen which is displayed on the liquid crystal display device 12.

### (Example of Variation 2)

A cable connection detection switch may be provided to each of the TV output terminal 105 and the HD output terminal 106, and a configuration for outputting a picture signal to the output terminal with which a cable connection has been detected may as well be taken. In this case, even when a display device is switched into any of the projector unit 6 and the liquid crystal display device 12 through either the display device selector switch or “Setting Menu of Display Device”, once detecting the cable connection to the TV output terminal 105, the CPU 101 generates, as substitute for generating projection data for the projector unit 6 (or display data for the liquid crystal display device 12), a picture signal that corresponds to the number of scanning lines of 525 and outputs this picture signal from the TV output terminal 105.

And, upon detecting the cable connection to the HD output terminal 106, the CPU 101 generates, as substitute for generating projection data for the projector unit 6 (or display data for liquid crystal display device 12), a picture signal that corresponds to the number of scanning lines of 1125 and outputs this picture signal from the HD output terminal 106.

In case of detecting the cable connection to both the TV output terminal 105 and the HD output terminal 106, the CPU 101 generates a picture signal that corresponds to the number of scanning lines of 1125, whose resolution is high, and outputs this picture signal from the HD output terminal 106.

### (Example of Variation 3)

The number of scanning lines of the picture signal which is generated in case of detecting the cable connection to both the TV output terminal 105 and the HD output terminal 106 may as well be configured to be selectable, not only to be the one with higher resolution. A selection operation is preferred to be made on “Menu Screen”.

### THIRD EMBODIMENT

The projector 10 in a third embodiment reads out management information of reproduction data from the memory card 110 or the hard disk drive device (HDD) 103, and switches between display devices based on the management information. Management information of reproduction data is configured to be able to specify a display device for image reproduction for each file where image data is stored.

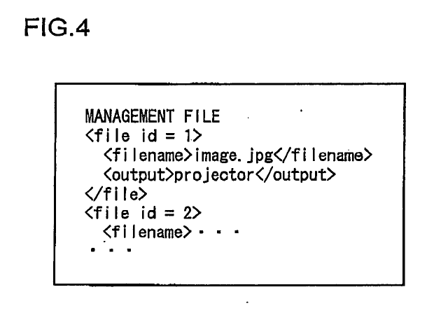

FIG. 4 is a drawing that illustrates management file in which management information of reproduction data is recorded. A management file is created differently from an image file and saved in the hard disk drive device (HDD) 103 or the memory card 110. In FIG. 4, the output (the display device) of a reproduction image of data in an image file is illustrated for each image file as “file id=1”, “file id=2”, and so on. According to FIG. 4, the file name of “file id=1” is “image.jpg”, and the output (the display device) of the reproduction image of data in this image file is “projector”, that is to say, the projector unit 6.

Upon instructed to reproduce an image by the data which is recorded in the image file with the file name of “image.jpg”, the CPU 101 refers to the management file and sends a projection instruction to an output (in this example, the projector unit 6) which is predetermined in the management file. The CPU 101 furthermore reads out image data from the file with the file name of “image.jpg”, generates projection data using this data, and sends out the generated data to the projector unit 6.

According to the third embodiment that is described above, the following operations and advantageous effects can be achieved.

(1) Creating management file in which management information of reproduction data is recorded, an output (a display device) of a reproduction image of data in an image file is made settable for each of image files. For example, by setting the liquid crystal display device 12 as the output (the display device) of images that a user does not want to show to others and setting the projector unit 6 as the output (the display device) of images that the user wants to show to others, the display device for the projector 10 to reproduce automatically the images is selectable to the user.
(2) Creating management file differently from image file enables a single management file to specify the output (the display device) of all image files; therefore, it is manageable to the user.

### (Example of Variation 4)

Information that describes the output (the display device) of a reproduction image may as well be included in the name of an image file. For example, being instructed to reproduce an image by data which is recorded in the name of an image file, “proj_out.jpg”, the CPU 101 sends the projection instruction to the output (in this example, the projector unit 6) that the file name describes. The CPU 101 furthermore reads out image data from the file with the name of “proj_out.jpg”, generates projection data using this data, and sends out the generated data to the projector unit 6.

### FOURTH EMBODIMENT

Management information of reproduction data in a fourth embodiment is configured to be able to specify a display device for image reproducing, for each folder where image files are stored.

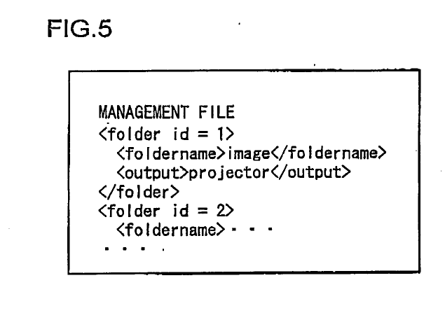

FIG. 5 is a drawing that illustrates management file in which management information of reproduction data is recorded. A management file is created differently from an image file and saved in the hard disk drive device (HDD) 103 or the memory card 110. In FIG. 5, the output (the display device) of a reproduction image by an image file in a folder is illustrated for each folder as “folder id=1”, “folder id=2”, and so on. According to FIG. 5, a folder name of “folder id=1” is “image”, and the output (the display device) of reproduction images of data in all of image files stored in this folder is “projector”, that is to say, the projector unit 6.

Upon instructed to reproduce an image by data of the image file which is recorded in the folder with the folder name of “image”, the CPU 101 refers to the management file and sends a projection instruction to the output (in this example, the projector unit 6) which is predetermined in the management file. The CPU 101 furthermore reads out image data from a specified image file, generates projection data using this data, and sends out the generated data to the projector unit 6.

According to the fourth embodiment that is described above, creating management file in which management information of reproduction data is recorded, an output (a display device) of a reproduction image by data in an image file is settable for each of folders in which image files are stored. Storing an image file in a different folder depending on the output (the display device) of a reproduction image is easy to handle and manageable to the user.

### (Example of Variation 5)

In a management file in which management information of reproduction data is recorded, the output (the display device) of a reproduction image of data in an image file may as well be configured to be settable for each of recording media. Storing an image file into a different recording media depending on the output (the display device) of a reproduction image is easy to handle and manageable to the user.

### (Example of Variation 6)

Information which describes the output (the display device) of a reproduction image may as well be included in the name of a folder. For example, upon instructed to reproduce an image by data which is recorded in the name of the folder, “proj_out”, the CPU 101 sends a projection instruction to the output (in this example, the projector unit 6) which the folder name describes. The CPU 101 furthermore reads out image data from a specified image file, generates projection data using this data, and sends out generated data to the projector unit 6.

### FIFTH EMBODIMENT

In the above described embodiments, an example of image reproducing using a single display device among a plurality of display devices is described. However, image reproducing using two display devices among a plurality of display devices, or not allowing any display device for image reproducing (that is to say, prohibiting any image reproduction) may as well be performed. In this case, likewise the third embodiment, it is preferable to record an output (a display device) of an image reproduction for each image file into a management file.

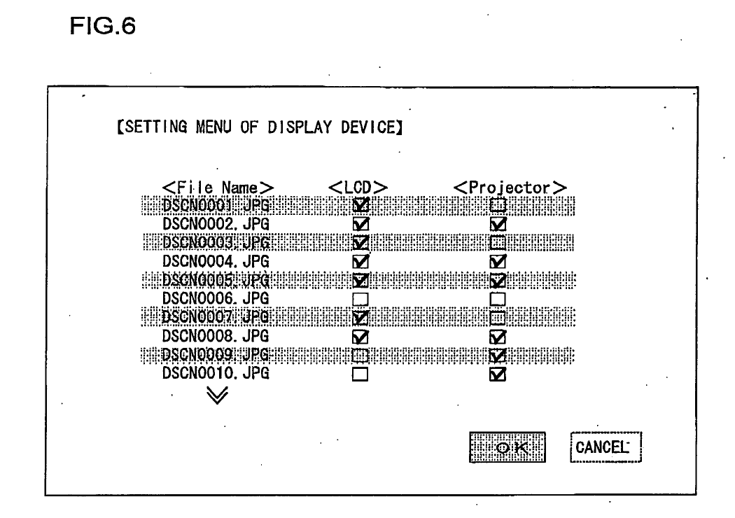

FIG. 6 is a drawing that illustrates an example of a menu screen for setting a display device for outputting a reproduction image. When a push down operation is made to the menu key that makes up the operation member 11, the projector 10 causes the liquid crystal display device 12 to display the setting menu screen of FIG. 6. According to FIG. 6, a check box is provided for “LCD” and “Projector”, for each image file. When the check box is ticked, the projector 10 controls a reproduction image by a corresponding image file to be displayed with the appropriate display device.

As for check boxes of image files with the file name of “DSCN0001.JPG”, “DSCN0003.JPG”, and “DSCN0007.JPG”, only “LCD” side is ticked. The output (the display device) of a reproduction image by data in each image file of this case is determined to be the liquid crystal display device 12, and is controlled not to be projected from the projector unit 6.

As for check boxes of image files with the file name of “DSCN0002.JPG”, “DSCN0004.JPG”, “DSCN0005.JPG”, and “DSCN0008.JPG”, each of “LCD” and “Projector” is ticked. The output (the display device) of a reproduction image by data in each image file of this case is controlled to be both the liquid crystal display device 12 and the projector unit 6.

As for check boxes of an image file with the file name of “DSCN0006.JPG”, none of “LCD” and “Projector” is ticked. A reproduction image by data in an image file of this case is controlled not to be displayed (projected) both on the liquid crystal display device 12 and on the projector unit 6.

As for check boxes of image files with the file name of “DSCN0009.JPG”, and “DSCN0010.JPG”, only “Project” side is ticked. The output (the display device) of a reproduction image by data in each image file of this case is determined to be the projector unit 6, and is controlled not to be displayed on the liquid crystal display device 12.

A next file to the file with the file name of “DSCN0010.JPG” is displayed, when the cursor key (the arrow key) for screen operation that makes up the operation member 11 is operated downwards in a state that the file “DSCN0010.JPG” is selected. When the check box “OK” is selected by a pointer operation member that makes up the operation member 11, as well as a push down operation is made to a decision key, the projector 10 quits the display of “Setting Menu of Display Device” screen and determines the display device that is ticked in check boxes as the output (the display device) of the reproduction images. When the check box “Cancel” is selected by the pointer operation member that makes up the operation member 11, as well as the push down operation is made to the decision key, the projector 10 quits the display of “Setting Menu of Display Device” screen and retains previous setting contents, regardless of contents that are ticked in check boxes.

The projector 10 records management information in which the output (the display device) of a reproduction image for each image file decided, as described above, in the memory card 110 or the hard disk drive device (HDD) 103. An initial state before any setting change is made in the setting menu is that the check box of “LCD” side is ticked and the check box of “Projector” side is blank (unticked), for all image files.

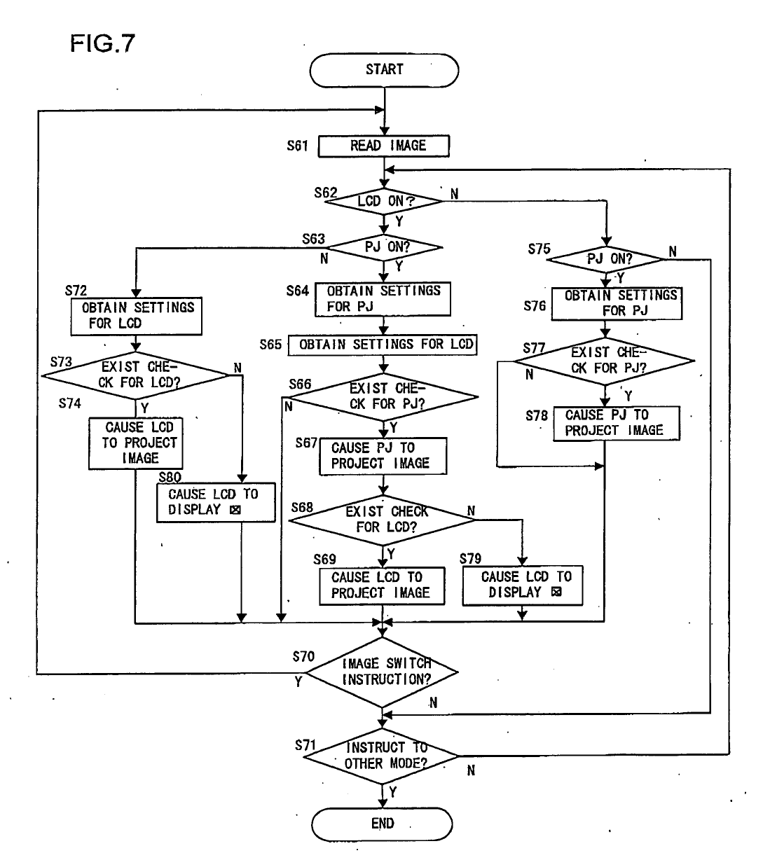

A description as to a flow of reproduction processing that the CPU 101 performs when the projector 10 performs image reproduction is given with reference to a flow chart of FIG. 7. When an operation signal that instructs an information reproduction start is input from the operation member 11, the CPU 101 starts processing of FIG. 7.

At a step S61, the CPU 101 reads out an image file from the memory card 110 or the hard disk drive device (HDD) 103, develops image data in the file in the memory 102, and proceeds to a step S62. As for reading out the image file, the image file is read out from a predetermined folder in the memory card 110 or the hard disk drive device (HDD) 103.

The projector 10 is configured to be selectable either an one frame reproduction system of displaying (projecting) one image at one screen, or a list reproduction system of displaying (projecting) a plurality of images at one screen, depending on an operation signal from the operation member 11. In this embodiment, a description with an example of the case of the list reproduction system is given. In the list reproduction system for displaying images of, for example, 9 frames on one screen, 9 image files are read out.

At the step S62, the CPU 101 judges whether a LCD is ON or not. When an ON operation signal is input from a LCD switch (not figured herein) that makes up the operation member 11, the CPU 101 judges the step S62 in an affirmative, and proceeds to a step S63; on the other hand, when the ON operation signal is not input from the LCD switch (not figured herein), the CPU 101 judges the step S62 in a negative, and proceeds to a step S75. In case of judging the step S62 in the affirmative, the CPU 101 puts the liquid crystal display device 12 into operation; on the other hand, in case of judging the step S62 in the negative, the CPU 101 does not put the liquid crystal display device 12 into operation.

At the step S63, the CPU 101 judges whether a PJ is ON or not. When the ON operation signal is input from the projector switch (not figured herein) that makes up the operation member 11, the CPU 101 judges the step S63 in the affirmative, and proceeds to a step S64; on the other hand, when the ON operation signal is not input from the projector switch (not figured herein), the CPU 101 judges the step S63 in the negative, and proceeds to a step S72. In case of judging the step S63 in the affirmative, the CPU 101 puts the projector unit 6 into operation; on the other hand, in case of judging the step S63 in the negative, the CPU 101 does not put the projector unit 6 into operation.

At the step S64, the CPU 101 obtains setting contents for the PJ and proceeds to a step S65. Concretely speaking, the CPU 101 reads out the above described management information, and obtains check results of check boxes of “Projector” as to the image files which were read out at the step S61.

At the step S65, the CPU 101 obtains setting contents for the LCD and proceeds to a step S66. Concretely speaking, the CPU 101 reads out the above described management information, and obtains check results of check boxes of “LCD” as to the image files which were read out at the step S61.

At the step S66, the CPU 101 judges whether a check for the PJ exists or not. When a check box of “Projector” is ticked as to an image file which was read out at the step S61, the CPU 101 judges the step S66 in the affirmative, and proceeds to a step S67; on the other hand, when a check box of “Projector” is not ticked, the CPU 101 judges the step S66 in the negative, and proceeds to a step S70.

At the step S67, the CPU 101 instructs to project a reproduction image by an image file whose check box of “Projector” is ticked, among the image files developed in the memory 102, from the projector unit 6, and proceeds to a step S68. In case of the one frame reproduction system, the CPU 101 instructs to project a reproduction image from the projector unit 6 on one frame by one frame basis.

At the step S68, the CPU 101 judges whether a check for the LCD exists or not. When a check box of “LCD” is ticked as to an image file which was projected at the step S67, the CPU 101 judges the step S68 in the affirmative, and proceeds to a step S69; on the other hand, when the check box of “LCD” is not ticked, the CPU 101 judges the step S68 in the negative, and proceeds to a step S79.

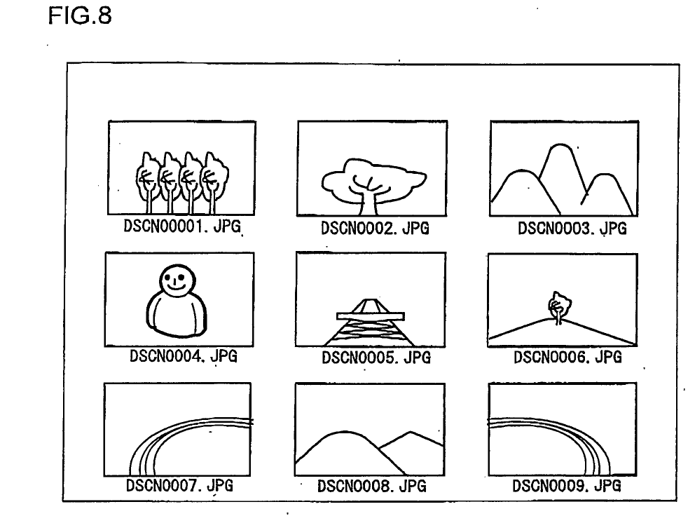

At the step S69, the CPU 101 instructs to display a reproduction image by an image file whose check box of “LCD” is ticked, among the image files projected at the step S67, on the liquid crystal display device 12, and proceeds to the step S70. FIG. 8 is a drawing that illustrates an example of the list (thumbnail) display screen which is displayed on the liquid crystal display device 12 in case all check boxes are ticked as to all image files which were read out at the step S61. The CPU 101 generates display data for the list display in the memory 102, sends generated display data to the liquid crystal display device 12. And, in case of the one frame reproduction system, the CPU 101 generates data for displaying a reproduction image by an image file of one frame which was read out at the step S61, and sends the generated display data to the liquid crystal display device 12.

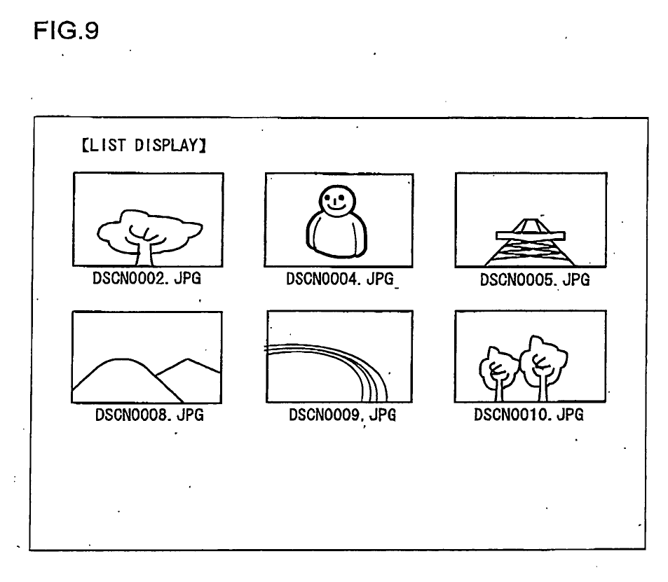

FIG. 9 is a drawing that illustrates an example of the list display screen which is projected from the projector unit 6 at the step S67, in case the checkbox is ticked as illustrated with the example in FIG. 6 as to an image file read out at the step S61. According to FIG. 9, only a reproduction image of an image file whose check box of “Projector” is ticked is projected; on the other hand, an existence of an image file whose check box of “Projector” is not ticked is hidden on the projection screen. Provided that the check boxes of “Projector” are ticked as to all image files which were read out at the step S61, the list display screen likewise FIG. 8 is projected from the projector unit 6.

At the step S79, as for an image file whose check box of “LCD” is ticked, the CPU 101 instructs to display a reproduction image by an image file developed in the memory 102 on the liquid crystal display device 12; on the other hand, as for an image file whose check box of “LCD” is not ticked, the CPU 101 instructs to display a mark (for example, X in a square) which represents a non-display (non-reproduction) setting on the liquid crystal display device 12, and proceeds to the step S70.

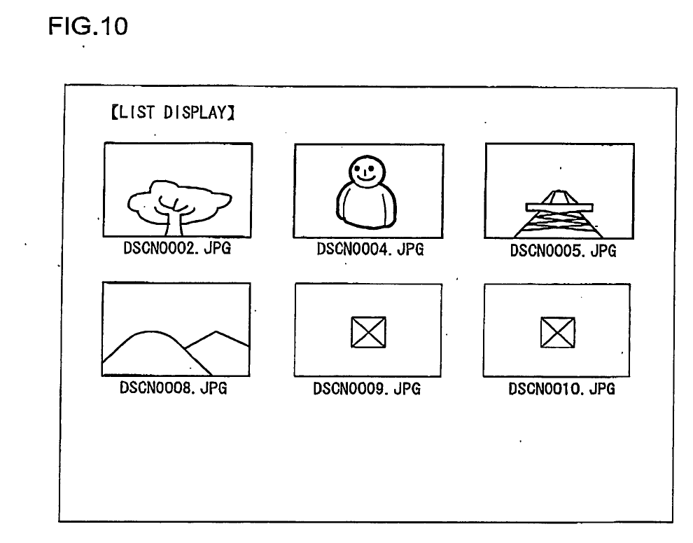

FIG. 10 is a drawing that illustrates an example of the list display screen which is projected from the liquid crystal display device 12 at the step S79, in case the check box is ticked as illustrated with the example in FIG. 6 as to an image file read out at the step S61. According to FIG. 10, an existence of only image files whose check boxes of “Projector” are ticked is made known; of these files, a reproduction image of the image file whose check box of “LCD” is ticked is displayed, while, as for the image file whose check box of “LCD” is not ticked, a mark that indicates a non-display setting is displayed. In case of the one frame reproduction system, if the check box of “LCD” is not ticked, as to an image file of an one frame which is read out at the step S61, the mark that indicates the non-display setting is displayed on the liquid crystal display device 12.

At the step S70, the CPU 101 judges whether an image switch instruction is made or not. When an operation signal which instructs to switch to a reproduction image by an other image file as an image for reproducing and displaying (projecting) is input from the operation member 11, the CPU 101 judges the step S70 in the affirmative, and returns to the step S61. When the operation signal to instruct to switch a reproduction image is not input from the operation member 11, the CPU 101 judges the step S70 in the negative, and proceeds to the step S71.

At the step S71, the CPU 101 judges whether a switch instruction to other mode (for example, the first embodiment) is made or not. When an operation signal which instructs to switch to an other mode is input from the operation member 11, the CPU 101 judges the step S71 in the affirmative, quits processing by FIG. 7, and starts processing of the other mode. When the operation signal which instructs to switch to the other mode is not input from the operation member 11, the CPU 101 judges the step S71 in the negative, and returns to the step S62.

At the step S72, the CPU 101 obtains setting contents for the LCD and proceeds to a step S73. Concretely speaking, the CPU 101 reads out the above described management information, and obtains check results of the check box of “LCD” as to an image file which was read out at the step S61.

At the step S73, the CPU 101 judges whether a check for the LCD exists or not. When the check box of “LCD” is ticked as to an image file which was read out at the step S61, the CPU 101 judges the step S73 in the affirmative, and proceeds to a step S74; on the other hand, when the check box of “LCD” is not ticked, the CPU 101 judges the step $73 in the negative, and proceeds to a step S80.

At the step S74, among the image files developed in the memory 102, the CPU 101 instructs to display a reproduction image of an image file whose check box of “LCD” is ticked on the liquid crystal display device 12, and proceeds to the step S70. At the step S80, as for an image file whose check box of “LCD” is ticked, the CPU 101 instructs to display a reproduction image by an image file developed in the memory 102 on the liquid crystal display device 12; on the other hand, as for an image file whose check box of “LCD” is not ticked, the CPU 101 instructs to display the mark (for example, X in a square) which represents the non-display setting on the liquid crystal display device 12, and proceeds to the step S70.

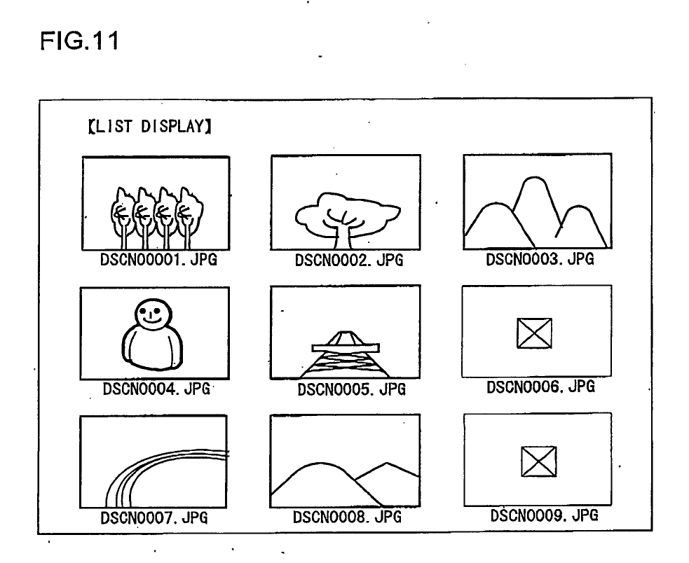

FIG. 11 is a drawing that illustrates an example of the list display screen which is displayed on the liquid crystal display device 12 at the step S80, in case the check box is ticked as illustrated with the example in FIG. 6 as to an image file readout at the step S61. According to FIG. 11, an existence of all image files read out at the step S61 is made known; of these files, a reproduction image of the image file whose check box of “LCD” is ticked is displayed, while, as for the image file whose check box of “LCD” is not ticked, the mark that indicates the non-display setting is displayed. In case of the one frame reproduction system, if the check box of “LCD” is not ticked, as to an image file of the one frame which is readout at the step S61, the mark that indicates the non-display setting is displayed on the liquid crystal display device 12.

At the step S75, CPU 101 judges whether the PJ is ON or not. When an ON operation signal is input from the projector switch (not figured herein) that makes up the operation member 11, the CPU 101 judges the step S75 in the affirmative, and proceeds to a step S76; on the other hand, when the ON operation signal is not input from the projector switch (not figured herein), the CPU 101 judges the step S75 in the negative, and proceeds to the step S71.

At the step S76, the CPU 101 obtains setting contents for the PJ and proceeds to a step S77 Concretely speaking, the CPU 101 reads out the above described management information, and obtains check results of the check box of “Projector” as to an image file which was read out at the step S61.

At the step S77, the CPU 101 judges whether a check for the PJ exists or not. When the check box of “Projector” is ticked as to an image file which was read out at the step S61, the CPU 101 judges the step S77 in the affirmative, and proceeds to a step S78; on the other hand, when the check box of “Projector” is not ticked, the CPU 101 judges the step S77 in the negative, and proceeds to the step S70.

At the step S78, among the image files developed in the memory 102, the CPU 101 instructs to project a reproduction image of an image file whose check box of “Projector” is ticked through the projector unit 6, and proceeds to the step S70. In case the check box is ticked as illustrated with the example in FIG. 6 as to an image file read out at the step S61, the list display screen which is projected from the projector unit 6 at the step S78 is the same as that of FIG. 9. In case of the one frame reproduction system, the CPU 101 instructs to project a reproduction image by an image file of an one frame which is read out at the step S61 from the projector unit 6.

According to the fifth embodiment that is described above, following operations and advantageous effects can be achieved.

(1) Of four outputs of a reproduction image by the projector 10, a configuration is made to be switchable among a mode for outputting to the LCD and the projector, a mode for outputting to the LCD or the projector, and a mode for outputting to neither the LCD nor the projector; therefore, an alternative of an image reproduction can be increased, compared to the case of outputting to one output invariably. And, a resolution of the liquid crystal display device 12 and the resolution of the projector unit 6 may as well be common (for example, 640 pixels wide×400 pixels long).
(2) In case the liquid crystal display device 12 is put into operation and the projector unit 6 is put into non-operation, of image files which are read at the step S61, a reproduction image by an image file whose check box of “LCD” is ticked is displayed on the liquid crystal display device 12; on the other hand, as for an image file whose check box of “LCD” is not ticked, the mark that indicates the non-display setting is displayed on the liquid crystal display device 12 (Steps S73, S74, and S80). By displaying the mark that indicates the non-display setting, an existence of an image file that is not to be displayed (reproduced) can be made known to the user of the projector 10.
(3) In case the projector unit 6 is put into operation and the liquid crystal display device 12 is put into non-operation, of image files which are read at the step S61, a reproduction image by an image file whose check box of “Projector” is ticked is projected from the projector unit 6; on the other hand, as for an image file whose check box of “Projector” is not ticked, information that indicates an existence of an image file is not included in project contents (Steps S77 and S78). By not displaying the mark that indicates the non-display setting, there is not a possibility for a viewer of a projection image to have a suspicion of the mark.
(4) In case both of the projector unit 6 and the liquid crystal display device 12 are put into operation, of image files which are read at the step S61, only an image file whose check box of “Projector” is ticked becomes a display object. A reproduction image by an image file of display object is projected from the projector unit 6 of this case; on the other hand, as for an image file which is not a display object, information that indicates an existence of an image file is not included in project contents (Steps S66 and S67). Meanwhile, of image files of display object, a reproduction image by an image file whose check box of “LCD” is ticked is displayed on the liquid crystal display device 12; on the other hand, as for an image file whose check box of “LCD” is not ticked, the mark that indicates the non-display setting is displayed (Steps S68, S69, and S79). By projecting (displaying) an image file that is common in a projection screen by the projector unit 6 and a display screen of the liquid crystal display device 12, a correspondence relation is easily comprehensible to the user of the projector 10. Moreover, on the projection screen of the projector unit 6, the mark that indicates the non-display setting is not projected; therefore, there is not a possibility for the viewer of a projection image to have a suspicion of the mark.

### (Example of Variation 7)

In the fifth embodiment, in a case of a list display and an one frame display, the example of deciding the output (the display device) of a reproduction image according to whether or not the check box is ticked is described. In addition to the case of the list display and the one frame display, it may as well be applied to the case of a slide show display.

### (Example of Variation 8)

And, a configuration of deciding the output (the display device) of a reproduction image according to whether or not the check box is ticked may as well be made selectable to, in response to an operation signal from the operation member 11, a system that applies to the case of the list display and the one frame display, a system that applies to the case of the slide show display, or a system that applies to any case. It is preferable that, as for the checkbox of “LCD”, an initial state in this case only employs the case of performing the slide show display; as for the check box of “Projector”, the initial state in this case employs each of cases of the slide show display, the list display, and the one frame display.

### (Example of Variation 9)

As in the case of displaying a screen illustrated in FIG. 10 on the liquid crystal display device 12, in case only an image file whose check box of “Projector” is ticked is a display object (a case of making an existence of an image file known), the liquid crystal display device 12 is made to perform a warning display when any of followings is performed: an operation of deleting image files of all frames, an operation of deleting a folder that includes an image file, or an operation of reformatting the memory card 110 or the hard disk drive device (HDD) 103. For example, displaying a message as “There is image files which are not displayed on a liquid crystal screen. Are you sure to lose these image files?” can prevent a possibility of losing image files by mistake.

### (Example of Variation 10)

As substitute for Example of Variation 9, in case only an image file whose check box of “Projector” is ticked is a display object (a case of making an existence of an image file known), any of followings may as well be prohibited (counted as invalid): the operation of deleting image files of all frames, the operation of deleting a folder that includes an image file, and the operation of reformatting the memory card 110 or the hard disk drive device (HDD) 103.

### (Example of Variation 11)

The number of display frames in one screen in the list reproduction system may as well be four frames or sixteen frames, not limited to nine frames which is described above.

(Example of Variation 12)

As for an image file whose check box of “LCD” is not ticked, the mark (for example, X in a square) which represents the non-display setting is displayed on the liquid crystal display device 12; however, in case the number of display frames in one screen in the list reproduction system is larger than a predetermined number (a display size per one frame is smaller than a predetermined size), an image of the frame may as well be reproduced and displayed without displaying the non-display setting mark. It is because contents of a display image are incomprehensible to the user in case the display image size becomes small to some extent.

### (Example of Variation 13)

The example of performing switching between check/non-check of the check box in the setting menu is described above, meanwhile it may as well be configured to be switchable also while performing the list display and the one frame display. The CPU 101 in this case, for example, once a predetermined password is input in a state of the list display and the one frame display, controls for displaying the check box next to the file name of a reproduction image on display, and controls for allowing the switch between check/non-check of the check box, while a reproduction image is being viewed.

### (Example of Variation 14)

The example of providing the check box for “LCD” and “Projector” is described above, the check box may as well be configured also for “TV output” and “HD output”. As in the case of the fifth embodiment, also in this case, since “LCD” is viewed exclusively by the user of the projector 10, an existence of an image file not to be displayed (reproduced) also is included in display contents; since “TV Output” and “HD Output” are viewed by a plurality of viewers as “Projector” is, as for an image file not to be displayed (reproduced), the file is excluded from display contents so that an existence of the file is not to be known.

As an example of an electronic device which includes a plurality of image reproduction means, the projector 10 is described above; however, the present invention can be applied to a cell phone equipped with a projector, a camera equipped with a projector, a television equipped with a projector, a radio equipped with a projector, and so forth.

Although various embodiments and examples of variation are described above, however the present invention is not to be limited only to those contents. The scope of the invention includes other possible embodiments invented within the scope of technical idea of the present invention.

The disclosures of the following priority application is herein incorporated by reference:

Japanese Patent Application No. 2005-294845 (filed Oct. 7, 2005)

1. An electronic device, comprising:
a first image reproduction unit that reproduces an image;
a second image reproduction unit that reproduces an image at a resolution different from that of the first image reproduction unit;
a reproduction data generation unit that generates reproduction data at a resolution according to an image reproduction unit by using image data; and
a control unit that instructs one of the first image reproduction unit and the second image reproduction unit alternatively image reproduction in response to a switching instruction, and that controls the reproduction data generation unit to generate reproduction data according to a resolution of an image reproduction unit that is instructed.

2. An electronic device according to claim 1, wherein:
the control unit instructs the image reproduction, and controls the reproduction data generation unit, in response to one of an operation signal from an operation member, a cable connection detection signal, and an instruction through an operation menu.

3. An electronic device according to claim 1, wherein:
the control unit instructs the image reproduction and controls the reproduction data generation unit, with respect to an image reproduction unit indicated by management information of reproduction data.

4. An electronic device according to claim 3, wherein:
the management information of the reproduction data is stored in a file other than a file in which image data is stored, and an image reproduction unit that reproduces an image is indicated for each file in which image data is stored.

5. An electronic device according to claim 3, wherein:
the management information of the reproduction data is stored in a file other than a file in which image data is stored, and an image reproduction unit that reproduces an image is indicated for each folder for storing a file in which image data is stored.

6. An electronic device according to claim 3, wherein:
the management information of the reproduction data is stored in a file other than a file in which image data is stored, and an image reproduction unit that reproduces an image is indicated for each recording media for storing a file in which image data is stored.

7. An electronic device according to claim 1, wherein:
the first image reproduction unit is a projection device.

8. An electronic device, comprising:
a first image reproduction unit that reproduces an image;
a second image reproduction unit that reproduces an image differently from the first image reproduction unit; and
a reproduction control unit that independently controls reproduction and non-reproduction of an image by means of the first image reproduction unit and the second image reproduction unit, in response to a first instruction which indicates whether or not to instruct the first image reproduction unit to reproduce an image, and a second instruction which indicates whether or not to instruct the second image reproduction unit to reproduce an image.

9. An electronic device according to claim 8, wherein:
the first instruction and the second instruction are given to each file where data of an image to be reproduced is stored.

10. An electronic device according to claim 9, wherein:
when instructing each of the first image reproduction unit and the second image reproduction unit to reproduce an image, the reproduction control unit (1) instructs the first image reproduction unit to reproduce and display, among images that are instructed to be reproduced by the second instruction, an image that is instructed to be reproduced by the first instruction; (2) instructs the first image reproduction unit to display information that shows non-reproduction related to, among images that are instructed to be reproduced by the second instruction, an image that is not instructed to be reproduced by the first instruction; and (3) instructs the second image reproduction unit to reproduce and display an image that is instructed to be reproduced by the second instruction.

11. An electronic device according to claim 9, wherein:
when instructing only the first image reproduction unit to reproduce an image, the reproduction control unit (1) instructs the first image reproduction unit to reproduce and display, among images that are stored in all files, an image that is instructed to be reproduced by the first instruction; and (2) instructs the first image reproduction unit to display information which shows non-reproduction related to, among the images that are stored in all the files, an image that is not instructed to be reproduced by the first instruction.

12. An electronic device according to claim 9, wherein:
when instructing only the second image reproduction unit to reproduce an image, the reproduction control unit instructs the second image reproduction unit to reproduce and display an image that is instructed to be reproduced by the second instruction.

13. An electronic device according to claim 8, wherein:
the first image reproduction unit is a liquid crystal display device, and the second image reproduction unit is a projection device.
